(19) United States
(12) Patent Application Publication
(10) Pub. No.: US 2010/0194714 A1
(43) Pub. Date: Aug. 5, 2010

(54) LED MATRIX DISPLAY DEVICE

(76) Inventor: I-Hsuan Hsieh, Miaoli County (TW)

Correspondence Address: EGBERT LAW OFFICES, 412 MAIN STREET, 7TH FLOOR, HOUSTON, TX, 77002, US

(21) Appl. No.: 12/670,550

(22) PCT Filed: Jan. 4, 2008
(86) PCT No.: PCT/CN2008/000033

§ 371 Date: Jan. 25, 2010

(30) Foreign Application Priority Data
Jul. 26, 2007 (CN) 20070138462.X

(51) Int. Cl. G06F 3/038

(52) U.S. Cl. 345/179

(57) ABSTRACT

An LED matrix device has sequential circuits, data drive circuits, scanning drive circuits and the LED matrix. The display elements at the junction of lines and rows include an infrared LED and at least one visible light LED each. Sequential circuits generate control signals to control the data and the scanning drive circuits, driving infrared and visible light LEDs. The sequential circuits produce group signals covering the line and row information of currently driven infrared LEDs and provide to the external light pen device for encoding the current position of the light pen. The function of the visible light LED is the same as in conventional LED matrixes. The infrared LED produces the position information needed by the light pen. An LED display can be many LED matrix devices in series, so the interface of the light pen for the present invention also has the function of series connection.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates generally to the field of photoelectric display, and more particularly to an LED matrix display device which has the light pen function.

2. Description of Related Art Including Information Disclosed Under 37 CFR 1.97 and 37 CFR 1.98

LED matrix devices have been massively used on large display boards as the unit price of LED lowers and it becomes more reliable. Recently, with the development of organic LED technology, LED matrix devices are also utilized on small portable products. However, the conventional LED matrix devices can display only, without the function of input.

Familiar display input modes include the touch screen and the light pen. Touch screen, either capacitive or resistive, is at high cost and a touch screen controller circuit must be added. Also, a touch screen must be calibrated after being used for a period of time. Light pen is cheap, with a light sensitive detector in the front end for sensing the sudden small change in brightness of a point on the screen. Otherwise, a light pen needs to receive horizontal and vertical synchronizing signals so as to determine the position of the light pen on the screen. However, light pens do not work without the background of light, so light pens are often used for the selection of single choices, which are generally reverse squares for the convenience of light pens. Therefore, light pens are not used in LED matrixes and common light pens cannot use on black background without light spots.

### BRIEF SUMMARY OF THE INVENTION

The present invention is to provide an LED matrix display device for solving the problem where light pens made by conventional technologies cannot work on backgrounds without light spots.

The present invention provides an LED matrix display device, comprising: an LED matrix, which further comprising a multiple of display elements at the junction of lines and rows, each of which comprises an infrared LED and at least one visible light LED. Line data drive circuits are included for receiving external data, driving the LED matrix to produce different visible light LED images and driving the infrared LED. Row scanning drive circuits are included and comprise a visible light LED row scanning drive circuit and an infrared LED row scanning drive circuit, producing row signals for driving the LED matrix. Sequential circuits produce signals for external light pens and signals for row scanning drive circuits and line data drive circuits.

Conventional LED matrix using the light pen can output the information of current display level and vertical position. However, the LED matrix is different from the CRT screen scanning in that CRT (Cathode Ray Tube) screen scanning is a scanning of light spots from upper to lower, from left to right. As long as the light sensitive detector of the light pen senses the light ray, it can generate the position information of the light pen according to the address counter completed by horizontal and vertical synchronizing signals from the screen and the frequencies. However, the LED matrix lightens a whole row of LEDs at a time. Thus, when the light pen senses the light rays, it can only tell which row lightens instead of giving correct information about which LED in which row gives the ray.

Therefore, an infrared LED is added to the display element at the junction of lines and rows of each LED matrix and the light sensitive detector of the external light pen is also replaced by an infrared receiver. For visible light part, the same drives as the conventional LED matrix stay unchanged and they can be line scanning or row scanning The infrared scanning can also be line scanning or row scanning, while the whole line (row) of visible lights are driven while the visible lights are scanned in lines (rows). In the present invention, the infrared LEDs in the same row will be lightened sequentially while the infrared light is scanning a line (row). In this way, it can be ensured that at any time there is no more than one infrared LEDs lightened. Thus, according to the sequential signals, the external light pen can get the line and row position information of the lighting infrared LED.

For connecting LED matrixes in series, additional control signals may be added to enable that the infrared LED can work one by one during the series connection, and LED matrix works through these control signals. Consequently, even if LED matrixes are in series connection, the external light pens can also operate as usual.

The scanning frequencies of the visible light and the infrared light are not necessarily the same. It can be decided by considering the number in the series connection and the infrared light scanning frequency and at the time of no series connection, the scanning frequencies can be the same for the purpose of simplifying circuits. The moment each point of the scanning infrared light in the same row (line) is lightened one by one, whether they are lightened statically or modulated depends on the position of light pens. If light pens are working directly on the LED matrix, static lighting is acceptable, but if light pens have a considerable distance from the LED matrix, the modulated mode can provide convenience for the filter amplifier circuit of light pens, and then demodulation circuits are used to tell whether modulated infrared light spot signals are received.

Another advantage of using the infrared LED is that the infrared LEDs belong to invisible light which will not disturb the display of visible light LED, thus they can be lightened one by one in rows and lines. Just because of this, it also overcomes the disadvantage of common CRT screen light pen which cannot sense the black part without light spots. Therefore, even if visible light LEDs have not been all lighted, the infrared LED part of the present invention's light pen still works as usual.

### BRIEF DESCRIPTION OF THE SEVERAL VIEWS OF THE DRAWINGS

FIG. 1 shows a schematic view of the circuit diagram of row scanning of LED display devices using conventional technologies;

FIG. 1A shows a schematic view of the circuit diagram of line scanning of LED display devices using conventional technologies;

FIG. 2 shows a schematic view of the circuit diagram of unicolor display element using conventional technologies;

FIG. 3 shows a schematic view of the circuit diagram of multicolor display element using conventional technologies;

FIG. 4 shows a schematic view of the circuit diagram of unicolor display element of the present invention;

FIG. 5 shows a schematic view of the circuit diagram of row scanning of LED display devices of the present invention;

FIG. 5A shows a schematic view of the circuit diagram of line scanning of LED display devices of the present invention;

FIG. 6 shows a schematic view of the sequential diagram of row scanning driving mode using conventional technologies;

FIG. 7 shows a schematic view of the sequential diagram of line scanning driving mode using conventional technologies;

FIG. 8 shows a schematic view of the sequential diagram of row scanning driving mode of the present invention;

FIG. 8A shows a schematic view of the sequential diagram of line scanning driving mode of the present invention;

FIG. 9 shows a schematic view of the sequential diagram of signals for external light pens of the present invention;

FIG. 10 shows a schematic view of the sequential diagram of signals for external light pens of the present invention in series connection;

FIG. 11 shows the schematic diagram of the present invention in series connection.

### DETAILED DESCRIPTION OF THE INVENTION

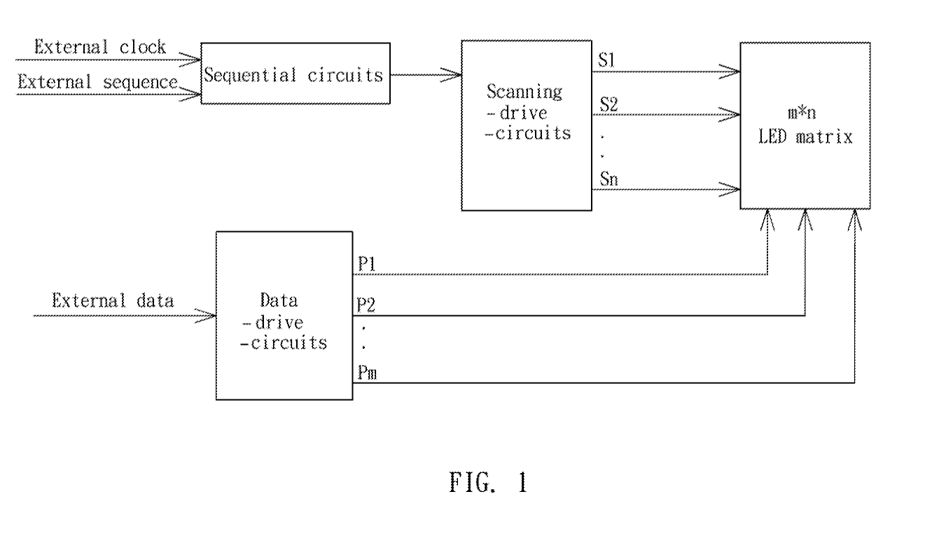

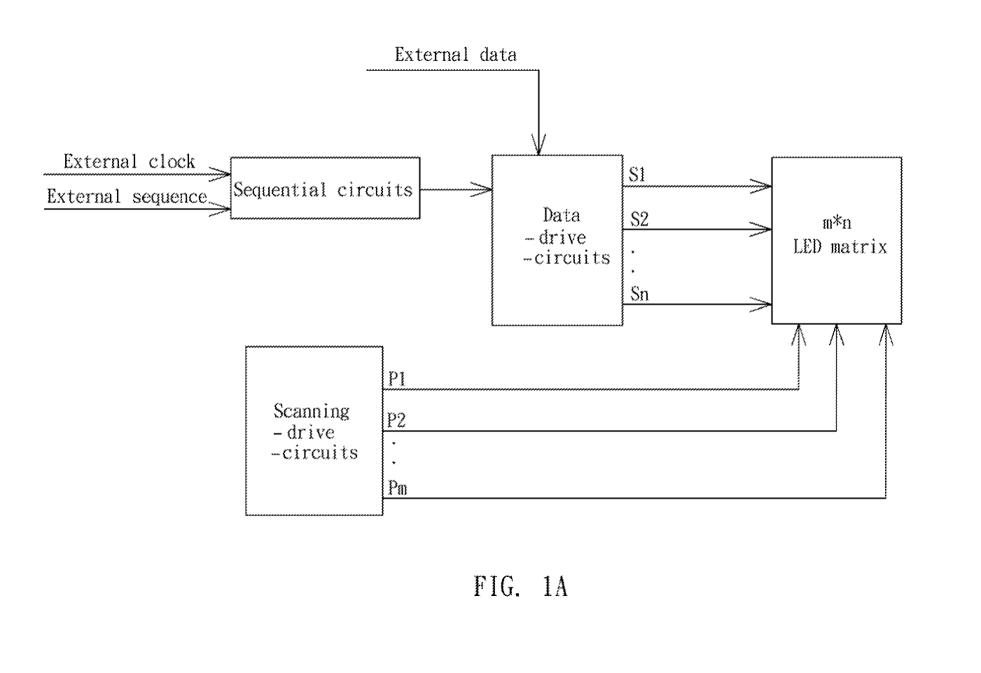

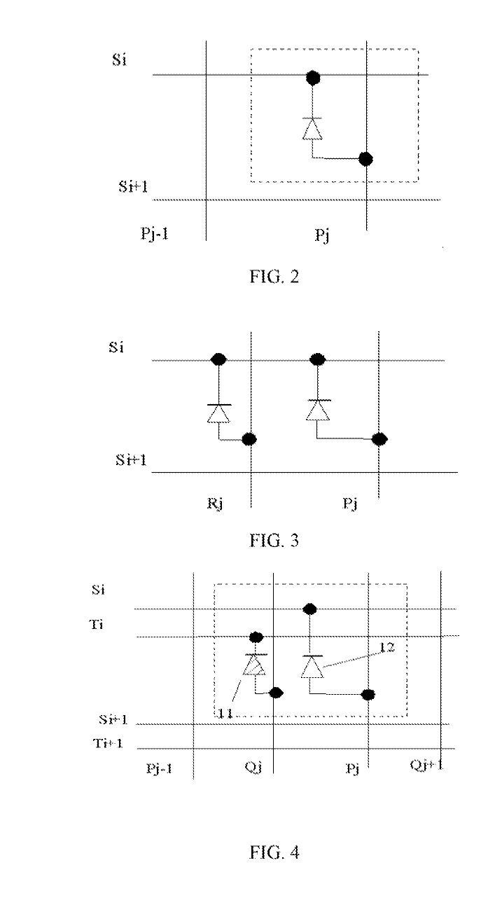

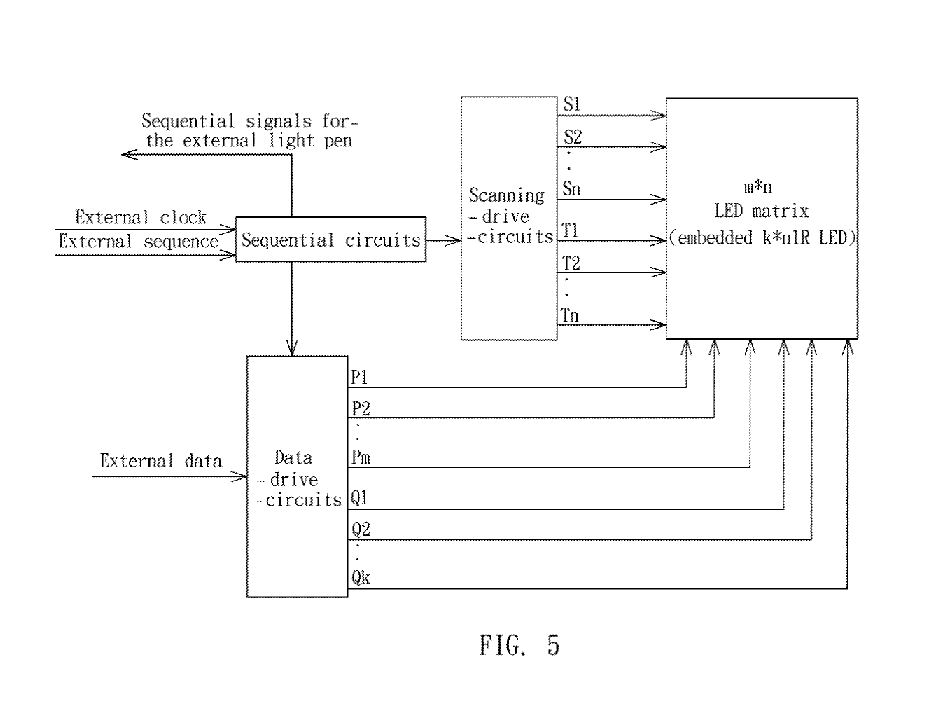

The conventional LED matrixes have two types as shown in FIG. 1 and FIG. 1A, which are two different control modes. FIG. 1 is the row scanning mode and FIG. 1A is the line scanning mode, but both of which display m(n) LED display elements in a row (line) at a time and totally display n(m) rows (lines) one by one. However, conventional LED display elements, in unicolor or multicolor LED matrixes, have one or more than one visible light LED(s) respectively, as shown in FIG. 2 and FIG. 3. Besides visible light display elements, the present invention adds an infrared LED. Taking the unicolor as an example, in FIG. 4, 11 is an infrared LED and 12 is a visible light LED. Because the present invention has not changed the conventional visible light part, the added infrared LED driving modes can be either line scanning or row scanning, both of which are similar. This indicates that the infrared LED scanning is primarily line scanning.

As for the line scanning, if every display element of a conventional LED matrix has r LEDs (multicolor has 2-3 LEDs of different colors and unicolor has only one), then every row of LEDs have k×r LEDs in total, that is to say, m=k×r. Despite the different number and colors of LEDs in the LED display elements, the unicolor and multicolor LED matrixes have the same driving mode, so the description for the present invention mainly concerns the unicolor ones, and the multicolor ones are regarded as a multiple of unicolor LEDs. In FIG. 1, the LED matrix scan lines S1-Sn are supplied with power in turn, the external data are transmitted to the data drive circuit, which sends out P1-Pm signals according to different data values to control the LED matrix for displaying relevant patterns. FIG. 1 is a common control mode and FIG. 1A is the design of U.S. Pat. No. 5,748,160, in which P1-Pm will generate different stepwise voltages from scanning drive circuits Taking the unicolor LED matrix as an example, firstly a voltage is applied to P1 and then P2 and downward in order of a line at a time. Every time the line which the voltage is applied to transmits external data to the data drive circuit to generate different S1-Sn control signals for lightening LEDs in a same line but different rows to produce the pattern needed.

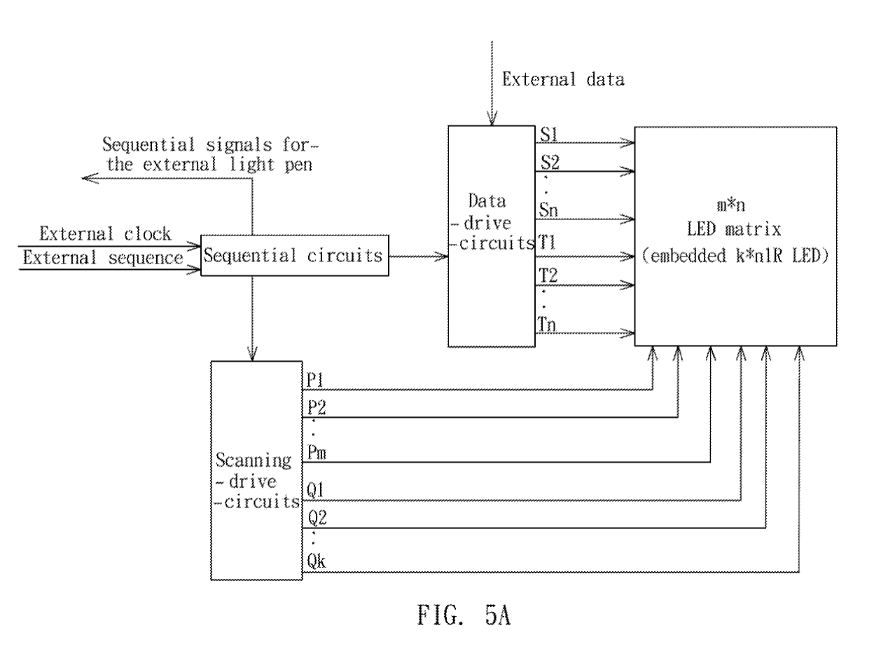

The present invention can apply the visible light LED matrix driving modes in FIG. 1 and FIG. 1A respectively in that it adds the infrared LED and the added drive circuits are for driving infrared LED and the drives for the visible light part stay unchanged. The present invention takes the visible light LED matrix display mode as the example for explaining how to drive the LED matrix added with embedded infrared LED, as shown in FIG. 5. For the drive in FIG. 5A, the visible light drive scanning mode is changed from original row scanning to be line scanning, so that its drive control mode is a little different from that in FIG. 5, but the principle of light pen operation part of FIG. 5A is the same as that of FIG. 5 and what's difference is just the line-and-row exchange.

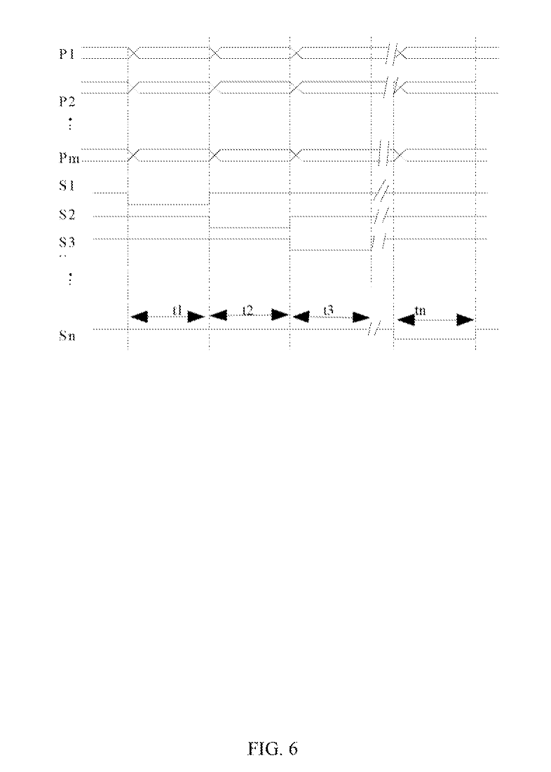

Considering the drive mode in FIG. 1, the FIG. 6 is the waveform of a conventional row scanning S1 begins to be supplied with power at time t1 , and from P1 and P2 to Pm, the whole row of voltages are controlled by external data input by user, producing the pattern of the first row LED lights. Then S2 is power supplied at time 2, the same procedure repeats and the pattern of the second row LED lights forms. In this order, S3, S4, . . . , Sn, the scanning of the whole image is completed. And then starting from S1, the next image is scanned in rows. The visible light scanning mode of the present invention is the same of conventional LED matrix, but for the additional infrared LEDs, as k×n infrared LEDs in FIG. 5, can supply T1 . . . Tn and Q1 . . . Qk drive signals and provide signals to light pen out of the LED device so that the light pen can calculate the line and row positions of infrared light spots now.

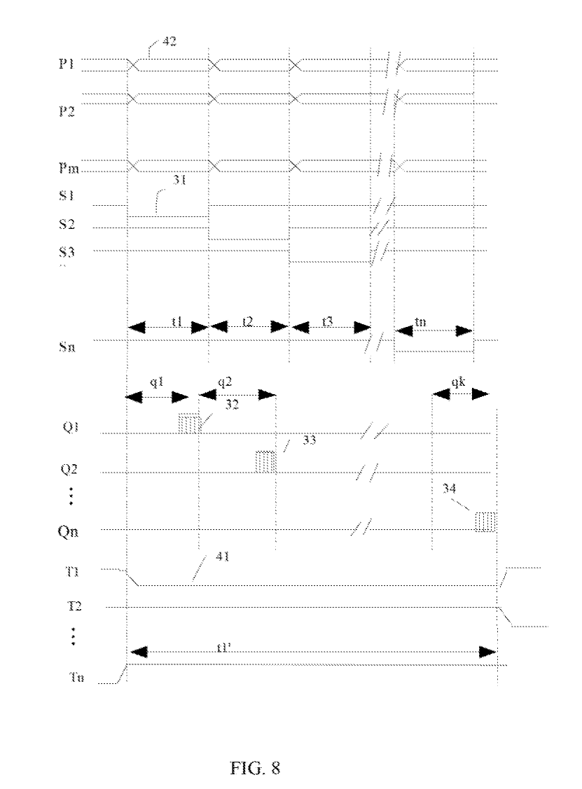

FIG. 8 shows the row scanning mode of the present invention, which is similar to that of visible light. The infrared LEDs are scanned in rows T1 . . . Tn and T1(41) power supply area is similar to that of S1(31). Different from P1 . . . Pm(42) of visible light and according to different external data drives, Q1, Q2, . . . Qk (32, 33, 34 in FIG. 8) of infrared light are lightened one by one in order and at the same time (q1, q2, . . . qn) there will be no more than one lighted infrared LED. The waveform for lighted LEDs can be the waveform of a static power supply state or that of a modulation frequency. The power supply period t1′ of T1 is not necessarily the same as t1 of S1 and it may be determined based on the size of the LED matrix and the number in the series connection. If t1′ is equal to t1, T1-Tn can be driven with the same waveform of S1-Sn. In this case, a part of the LED matrix may not have T1-Tn pins; instead, the original connections to T1 -Tn in the LED matrix is changed to S1˜Sn. Thus, the system design of the present invention can be simplified.

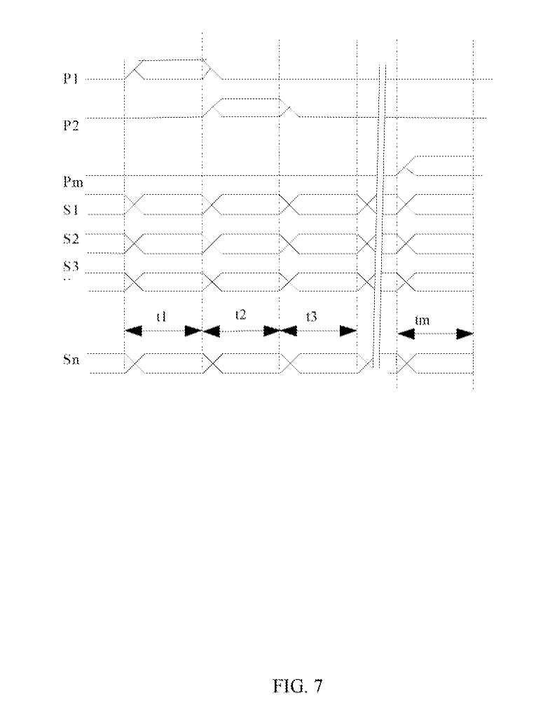

FIG. 1A is a conventional LED device of line scanning Although its scanning mode is quite different from that in FIG. 1, the visible light LED part of the present invention stays unchanged, but it is changed from row and row to line and line for fitting the external data. The infrared scan signals change from row scanning to line scanning and FIG. 8A shows the way of line scanning of the present invention. FIG. 7 is the drive mode of conventional line scanning As seen, the line drive signals are from P1, P2, to Pm, and transmits power supply signals at t1, t2, . . . tm, and S1 to Sn sends out signals for light on or off according to external data. FIG. 8A is the drive mode of line scanning of the present invention, which has similarity with the row scanning in FIG. 8 in that during scanning of infrared LED, either in lines or in rows, infrared LEDs must be lighted one by one in order as 32A, 33A and 34A in FIG. 8A. There should be no more than one lighted infrared LED at the same time so that external light pen can detect the positions of infrared light spots. With the same principle as row scanning in FIG. 8, if t1′ is the same with t1×r in FIG. 8A, a part of P1-Pm signals can be directly taken (one for every r, viz. take Qixr and i=1-k) to drive Q1-Qk and thus simplifying the system configuration.

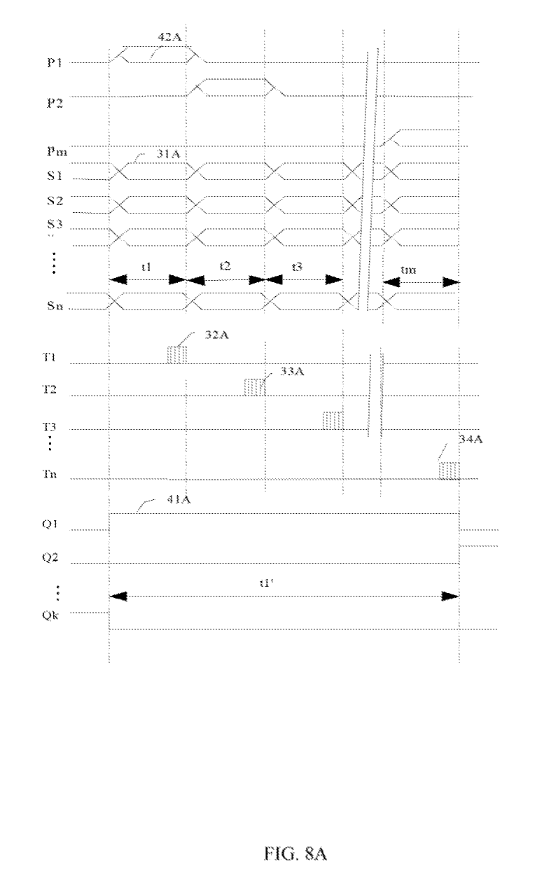

FIG. 9 shows the signals provided by the present invention to external light pens. TRIG is the triggering signal for external light pens sensing infrared lights. HS (21) and VS (22) are signals provided by the present invention to external light pens. The fixed ratio of HS to keeping synchronization with row (or line) scanning signals and period is M and the fixed ratio of VS to keeping synchronization with row (or line) scanning signals of the first row (line) and period is N. Thus, the rate of the time difference tg of rising edge of TRIG triggering point to rising of VS to VS period tv is Y, the rate of the time tp of TRIG from the previous HS and th is X, and then which scan line and which infrared LED triggers is known. Further, the position of light pen is known. The detailed calculation is as follows:

X=tp/th;

Y=tg/tv;

th =M×t1; (row scanning t1′ for reference in FIG. 8, and line scanning t1′ for reference in FIG. 8A)

tv=N×t1′×n; (at the time of row scanning, t1′ and n see references in FIG. 8)

tv=N×t1′×k; (at the time of line scanning, t1′ and k see references in FIG. 8A)

Because x is the position of triggering light spot in the same row (line) and y is its position in which scanning row (line), relevant to t1′ and t1′×n (t1′×k at the time of line scanning)

x=tp/t1′=tp/(th/M)=M×(tp/th)=M×X;

y=[tg/(t1′×n)]=[tg/(tv/N)]=[N×(tg/tv)]×[N×Y]; ([]: round number calculation)

y=[tg/(t1′×k)]=[tg/(tv/N)]=[N×(tg/tv)]=[N×Y]; (line scanning)

In view of this, an external light pen can calculate the position information of it in the LED matrix display. Here, why the simplification is calculated with X, Y, M, N is due to the fact that M, N are known parameters during the system design. X, Y are relative to HS, VS so that it is easy for the external light pen to get the internal frequency and it is set to be a counter to calculate the widths of HS, VS and TRIG respectively and get them. The values of M, N can be 1 or other fixed value for the convenience of system frequency design of the external light pen.

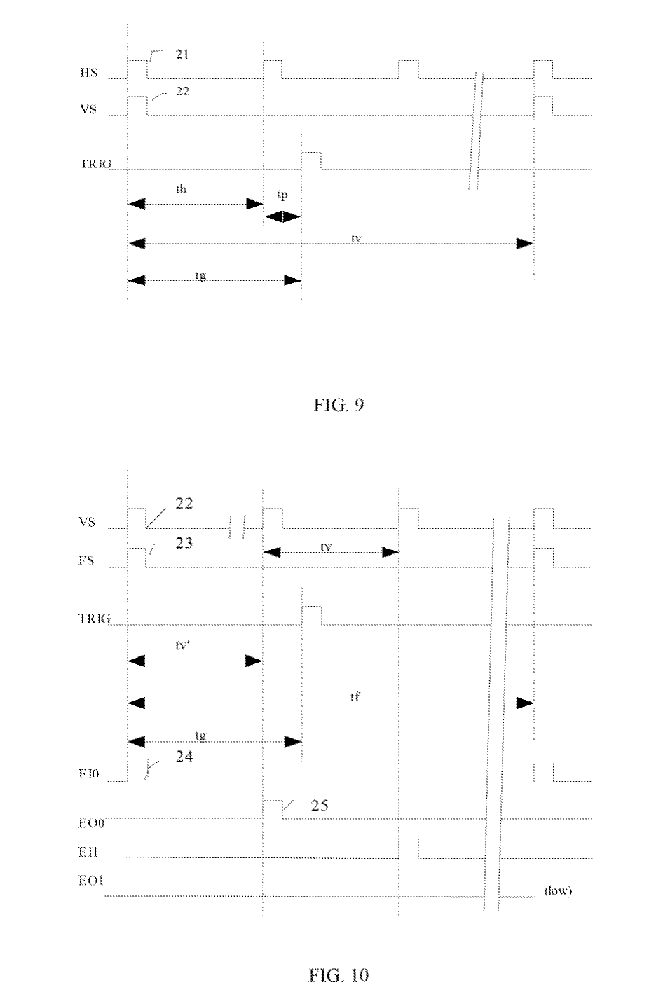

For series connection of LED matrix, another three control signals, EI (24), EO (25) and FS (23) are shown in FIG. 10. FS is the FRAME synchronizing signal which is synchronized with the period of the scanning plane. If there are a LED matrixes in series, the period tf of FS is a times of the period of the whole scanning plane, tv′. That is, in FIG. 10,

tv′=t1′×n (at the time of row scanning, t1′ and n see references in FIG. 8)

tv′=t1′×k (at the time of line scanning, t1′ and k see references in FIG. 8A)

tf=a×tv′

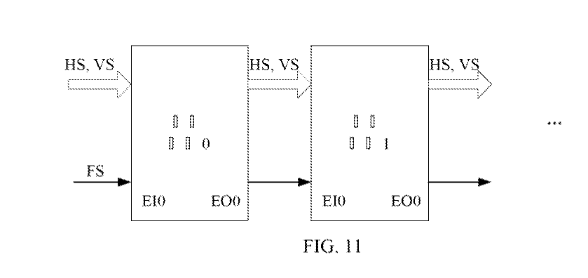

EI is the power input signal of external infrared device and EO is the power output of the next stage infrared device. During the system reset, EO output is in the state of deenergization. When the tv′ period begins and EI input is power supply, the infrared LED part of this LED matrix in the tv′ period functions. After EI signal begins to supply power at the tv′ period, EO will supply power in the next tv′ period to enable the LED matrix in the next series to work in that period. In this way, the infrared LED part will work one device after another and once for a tv′ period. The mode of series connection is as shown in FIG. 11, and the control comprises HS and VS signals in FIG. 9. HS, VS and FS come from the sequential circuit. During series connection, the external light pen must calculate the proportion of th, tv and tg with the information about HS and VS in FIG. 9 and also the proportion of FS periods, tf and tg, so as to deduce TRIG occurs when the VS period of which LED matrix in series connection works. In addition, the line and row position calculation in series connection is the same as that of not being in series connection.

As stated above, the device of the present invention adds infrared LEDs in the conventional LED matrix display elements and infrared LED drive signals besides the conventional visible light drive signals, which enables that there will not be more than one LED in the state of power on at any time. Plus the synchronizing signals HS and VS provided by sequential signals of the present invention to the external light pen, the light pen can calculate the row and line position of infrared light triggering spot. Otherwise, in series connection, the present invention also provides the synchronizing signal FS for using devices in series connection so that the external light pen can calculate which device gives out the infrared light spot. The external infrared device power input signal EI and the power output signal EO of the next stage infrared device, as the series connection shown in FIG. 11, can make only one device of the infrared part of the LED matrix device in power on at any moment. Therefore, the external light pen is able to calculate which LED matrix device in series connection triggers according to the position relationship of infrared LED triggering point and FS. Compared with conventional LED matrix, the present invention provides a light pen interface, which was unavailable before, and embeds the invisible light infrared LED to overcome the disadvantage of conventional CRT screen light pen that it cannot sense the area without light spots. The present invention also provides signals for series connection. It is novel and advanced with values in business applications.

Although the invention has been explained in relation to its preferred embodiment, it is to be understood that many other possible modifications and variations can be made without departing from the spirit and scope of the invention as hereinafter claimed.

I claim:

1. An LED matrix display device, comprising:
an LED matrix, which further comprising a multiple of display elements at the junction of lines and rows, each of which comprises an infrared LED and at least one visible light LED;
line data drive circuits for receiving external data, driving the LED matrix to produce different visible light LED images and driving said infrared LED;
row scanning drive circuits, comprising a visible light LED row scanning drive circuit and an infrared LED row scanning drive circuit, producing row signals for driving said LED matrix; and
sequential circuits, producing signals for external light pens and signals for row scanning drive circuits and line data drive circuits.

2. The structure defined in claim 1, wherein, said line data drive circuits drive said infrared LED in the same row one by one in the static or fixed frequency modulation mode, so that there will not more than one infrared LED driven at a time.

3. The structure defined in claim 1, wherein, said infrared LED row scanning drive circuits drive said infrared LED in rows in fixed time so that there will be no more than one row infrared LEDs driven at any time.

4. The structure defined in claim 1, wherein, the signals used by said sequential circuit for the external light pen comprising:
the signal synchronous with the scanning row, and the external light pen calculates the line position of light spots according to the positions of the light spot triggering point and said signal;
the signal synchronous with the first row of the scanning row, and the external light pen calculates the position of light spot row according to the positions of the light spot triggering point and said signal.

5. The structure defined in claim 4, wherein, said signals for the external light pen at the time when said devices are in series connection comprising:
the signal synchronizing with the first scanning device, and the external light pen calculates the line position of light spot device according to the positions of the light spot triggering point and said signal;
the external infrared device drive input signal, for the drive output of the last stage device;
the next stage infrared device drive output signal, for the drive input of the next stage device.

6. An LED matrix display device, it comprising:
an LED matrix, which further comprising a multiple of display elements at the junction of lines and rows, each of which comprises an infrared LED and at least one visible light LED;
row data drive circuits for receiving external data, driving the LED matrix to produce different visible light LED images and driving said infrared LED;
line scanning drive circuits, comprising a visible light LED line scanning drive circuit and an infrared LED line scanning drive circuit, producing row signals for driving said LED matrix; and
sequential circuits, producing signals for external light pens and signals for line scanning drive circuits and row data drive circuits.

7. The structure defined in claim 6, wherein, said row data drive circuits drive said infrared LED in the same line one by one in the static or fixed frequency modulation mode, so that there will not more than one infrared LED driven at a time.

8. The structure defined in claim 6, wherein, said infrared LED line scanning drive circuits drive the infrared LED in lines in fixed time so that there will be no more than one line infrared LEDs driven at any time.

9. The structure defined in claim 6, wherein, the signals used by said sequential circuit for the external light pen comprising:
the signal synchronous with the scanning line, and the external light pen calculates the row position of light spots according to the positions of the light spot triggering point and said signal;
the signal synchronous with the first line of the scanning line, and the external light pen calculates the line position of light spot according to the positions of the light spot triggering point and said signal.

10. The structure defined in claim 6, wherein, said signals for the external light pen at the time when said devices are in series connection comprising:
the signal synchronous with the first scanning device, and the external light pen calculates the line position of light spot device according to the positions of the light spot triggering point and said signal;
the external infrared device drive input signal, for the drive output of the last stage device;
the next stage infrared device drive output signal, for the drive input of the next stage device.
